(19) United States
(12) Patent Application Publication
(10) Pub. No.: US 2014/0217095 A1
(43) Pub. Date: Aug. 7, 2014

(54) Tool Caddy Carrier, Organizer, and Storage Device

(71) Applicant: Joseph V. Scivoletto, Margate, FL (US)

(72) Inventor: Joseph V. Scivoletto, Margate, FL (US)

(21) Appl. No.: 14/078,978

(22) Filed: Nov. 13, 2013

Related U.S. Application Data
(60) Provisional application No. 61/727,673, filed on Nov. 17, 2012.

(51) Int. Cl. B65D 51/24; B25H 3/00

(52) U.S. Cl. CPC B65D 51/24; B25H 3/00
USPC 220/212

(57) ABSTRACT

The present invention is a device embodying a container and container lid or lid shaped device with incorporated slits, grooves, pockets, netting, meshing, compartments, baskets, notches, trays and/or cut outs for the organizing, holding, storing, and carrying of tools.

### CLAIM OF PRIORITY

This application claims priority to Provisional Application for U.S. Patent No. 61/727,673 filed Nov. 17, 2012.

### FIELD OF THE INVENTION

The present invention relates to a device that combines with an ordinary bucket and handle for carrying, organizing and holding tools. The invention relates to a unique tool caddy specifically designed to appropriately fit, store, and enable the effortless and safe carrying, and organizing of Stools. There are several possible embodiments of this invention comprising a standalone lid, which can be attached to an ordinary bucket, thus transforming the bucket into a tool caddy, and a fully integrated bucket with incorporated tool caddy lid slots.

### BACKGROUND OF THE INVENTION

It is customary for mechanical tools, carpentry tools, and many others to be stored and carried within specifically designed caddy devices. It is only natural that tools, such as garden implements, be stored and transported similarly. Traditionally, racks, hangers, and shelves have been used to store ones' garden tools.

Several prior inventions have tried to accomplish this objective by developing portable tool caddy devices. These caddy devices help aid in the utilization of such equipment and significantly increase their ease of transport and storage.

The present invention is a cost-efficient garden implement caddy that also serves as a proper, neat, and safe organizer, holder, caddy, carrier, and bucket all in one. While prior art has made the transportation of garden tools possible, the current invention provides for a more convenient and efficient manner of transporting said tools. Such convenience and efficiency stems from the attachment of the product onto an ordinary bucket in which tools can be placed and stored within and/or around When the storage product is attached to the ordinary bucket, the bucket is transformed into a caddy device with specially designed prearranged holes and recessions for clean, neat, easy and safe storage, organization, and mobility for a large quantity of garden implements.

### BENEFITS AND KEY POINTS

Some of the benefits and key advantages of the present invention are as follows: The present invention being utilized in conjunction with an ordinary bucket makes the final product is extremely cost-efficient. The present invention mitigates the occurrence of accidents caused by tools moving within the caddy during transport by incorporating unique and carefully designed tool slots, slits, grooves, cut-outs, holes, notches, pockets, netting, mesh, compartments, baskets, and/or trays to secure specific implements safely away from the users handle. Additionally, the current invention's prearranged and per-positioned tool slots, slits, grooves, cut-outs, holes, notches, pockets, netting, mesh, compartments, baskets, and/or trays allow the caddy to double as a tool organizer making it effortless to find the right tool for the job. This novel and innovative design neatly organizes and efficiently and conservatively holds tools within an ordinary container, which provides for safe and convenient mobility of the present invention, the bucket, and the tools being stored within.

### SUMMARY OF INVENTION

It is the primary object of the present invention to provide a garden tool caddy with an incorporated gardening bucket. The inclusion of a gardening bucket into the current invention's design is paramount to the invention to produce a truly convenient and space efficient product. This design and utility inclusion allows for the present invention to satisfy the market need for a truly efficient product. The inclusion of a gardening bucket within the unit's design ultimately saves the user storage space. Instead of having to store a gardening bucket and a garden tool caddy, now the user must only make room for a single product, which incorporates the features of a tool caddy as well as a bucket. Along the same lines, rather than having to carry a garden caddy and a gardening bucket, the present invention allows the user the convenience and ease of transporting a single combined unit. This innovative and conservative design is also a cost-efficient alternative to the user buying a gardening bucket and a tool caddy individually.

It is a further object of the present invention to provide a way to neatly store and organize ones' gardening tools. As a result of prearranged, tool placement slots, the current invention provides the user with a simple and effective means to neatly store and organize their gardening implements. The present invention incorporates specifically designed slots purposefully for each individual tool. This unique specialization makes the current invention perfect for the user to keep track and account of all their gardening implements.

Aside from neatly holding gardening tools, the prearranged slots serve another objective of the current invention, which is to securely hold in place the tools for safe transport. Unlike prior art, the present invention's per-cut slots are thoughtfully positioned to guarantee the handle-area remains free of any sharp tools. This is accomplished by thoughtful slot placement and specifically designed slot size, which aid in holding tools securely in place at an ideal and safe location during transport.

The present invention is a device for organizing, holding, storing, and/or carrying tools comprising of at least one: a container lid or a lid shaped device having at least one of: slit(s), groove(s), cut-out(s), pocket(s), netting, meshing, compartment(s), basket(s), notch(es), tray(s), and/or hole(s). Wherein at least one of the various slit(s), groove(s), cut-out(s), pockets, netting, meshing, compartment*s), basket(s), notch(es), tray(s), and/or hole(s) may be for the vertical placement, insertion, separation, support, and/or storage of a multitude of tools. Wherein said lid or lid shaped device may be sized to rest on top of the upward opening of a container and may partially, or wholly, align with container's diameter and perimeter walls.

The present invention may incorporate said variable forms of openings to be positioned so the various tools may be inserted and positioned, and/or held in place, and/or supported into and/or around a container. The present invention may utilize a container, such as a bucket with a pivotal handle fastened to at least one of its outer diametrical walls, to serve as an upward open receptacle device for the support of tools, which include but are not limited to gardening tools, electrical tools, plumbing tools, auto-mechanical tools, and/or other everyday household tools. The invention may contains slit(s), groove(s), cutout(s), and/or notches(s) on its outer diameter for the container's pivotal handle to fit securely within when the handle is inclined into its most upward vertical carrying position, thus securing the handle and the invention with one another.

It may be a further attribute of the present invention to incorporate at least one attachable side mesh basket(s), tray(s), pocket(s), compartment(s), meshing, and/or netting that hang in alignment underneath at least one of the lid or lid shaped device's openings, hole(s), notches(s), tray(s), cut-out(s), and/or groove(s). The attachable side meshing, baskets, pockets, compartments, and/or trays may be attached to at least one of the outer walls of the lid, thus extending the total surface area and carrying volume and capabilities of the present invention;

At least one of the present invention's said attachable side mesh, baskets, netting, pockets, compartments, and/or trays may be attached to at least one of the outer walls of the specialized lid or lid shaped device. through the use of a connecting device. This connecting device may be a constructed of a flat and/or round, metal, rubber, and/or plastic, stake, pin, hook, latch, hinge and/or clip.

The present invention's slit(s), groove(s), cut-out(s), pocket(s), netting, meshing, compartment(s), basket(s), notch(es), tray(s) and/or hole(s) may be differentially shaped and at least two or more may be of different size. In addition, at least one of said lid or lid shaped device's slit(s), groove(s), cut-out(s), notch(es), tray(s), pocket(s), netting, meshing, compartment(s), basket(s) and/or hole(s) may be interlined with a material and/or fabric that may or may not conform to the shape of the inserted implement and secure it within the respective slit, groove, cut-out, notch, tray, pocket, netting, meshing, compartment, basket, and/or hole.

### DESCRIPTION OF SOME OF THE PRESENT INVENTION'S SUGGESTED TOOL ASSIGNMENTS

The invention is designed to, but is not limited to, hold, carry, store, and organize the following tools, comprising of the following means:

Small oval holes as illustrated in FIG. 1(5A)-1(5D)—machetes, corn knives, saws, and thin handled tools.

Attachable side mesh baskets/trays as illustrated in FIG. 2(9)—gloves, tape measures, marking paints, and hand-pruners.

Large top holes as illustrated in FIG. 1(4) shovel heads up to seven inches in width

Middle oval holes as illustrated in FIG. 1(2) for extended handled tools—such as but not limited to: loppers (up to four feet), shears, sledge hammers, shovels, saws, painter and janitorial tools, golf course maintenance tools, barbecue utensils, brooms, dust pans, grabber sticks, machetes, knives and hatchets, tree stakes, measuring sticks, and watering wands.

Bucket handle hole as illustrated in FIG. 1(3)—hammers, hatchets, hand shovels, axes, trenchers, mini rakes, claws, and stakes

### BRIEF DESCRIPTION OF THE DRAWINGS

Note that within the Brief Description of the Drawings and the Detailed Description it is possible that the following terms: holes, slits, slots, grooves, baskets, trays, cut-outs, meshing, netting, compartments, and/or pockets may be used interchangeably. The use of one of these terms in any descriptions is for illustration and descriptive purposes only does not limit the invention to only using that specific term used.

FIG. 1 is a frontal prospective view of the garden caddy lid.
FIG. 1(1) depicts a surface view of the caddy lid. From this angle the placement of the numerous openings, cut-outs, and holes for the holding, organizing, and carrying of tools are clearly illustrated.
FIG. 1(2) depicts the shape and placement of the present invention's middle oval holes.
FIG. 1(3) depicts the shape and placement of the present invention's bucket handle side holes.
FIG. 1(4) depicts the shape and placement of the present invention's large top holes.
FIG. 1(5A)-1(5D) depicts the shape and placement of the present invention's small oval holes.
FIG. 1(6) depicts the shape and placement of the present invention's bucket handle support cut-outs. These apertures allow the handle to lock in an upright position for safer and easier transportation of the tool caddy.

FIG. 1A is a rear prospective view of the garden caddy lid.

FIG. 1B is a front-side angled view of the garden caddy lid.

FIG. 1C is a rear-side angled view of the garden caddy lid.

FIG. 1D is a side view of the garden caddy lid.

FIG. 1E is shaded frontal prospective view of the garden caddy lid.

FIG. 1F is a shaded front-side angled view of the garden caddy lid.

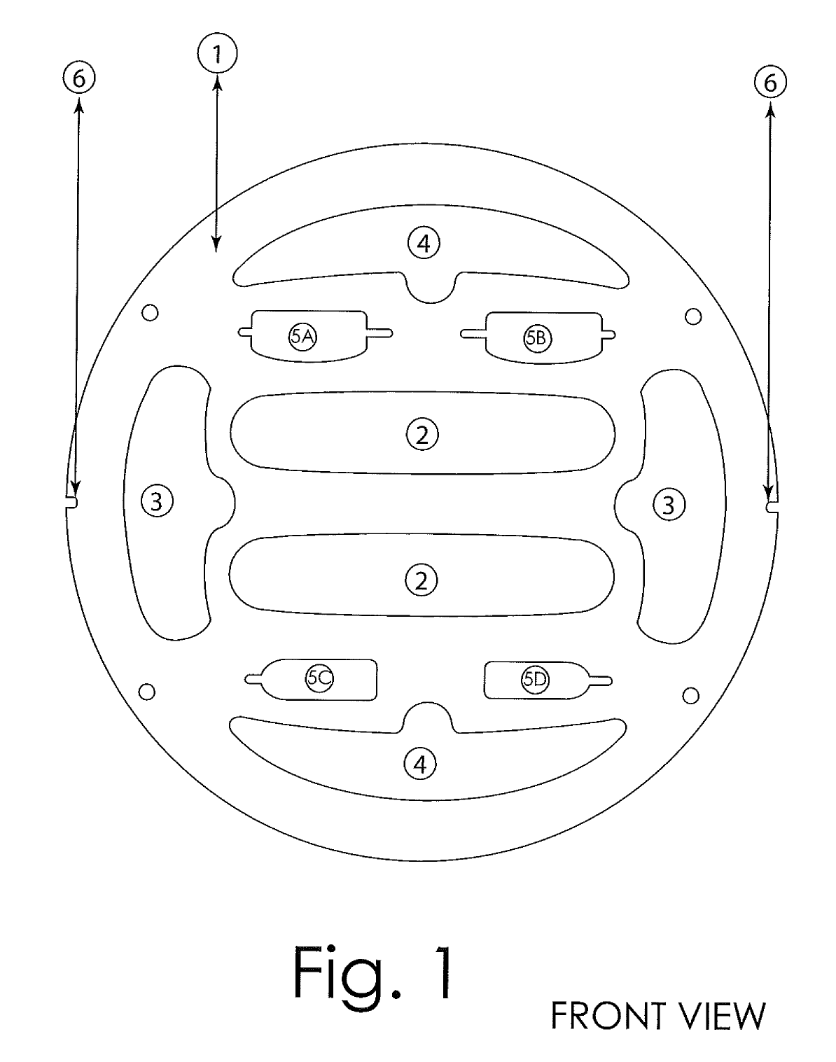

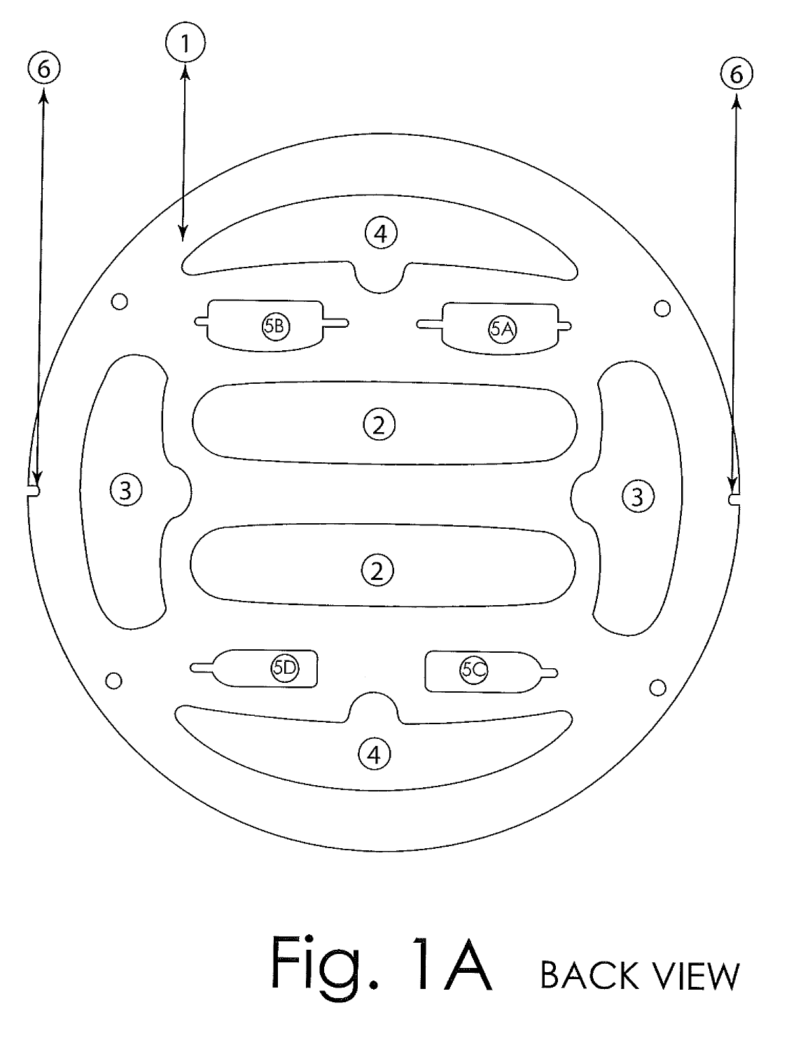

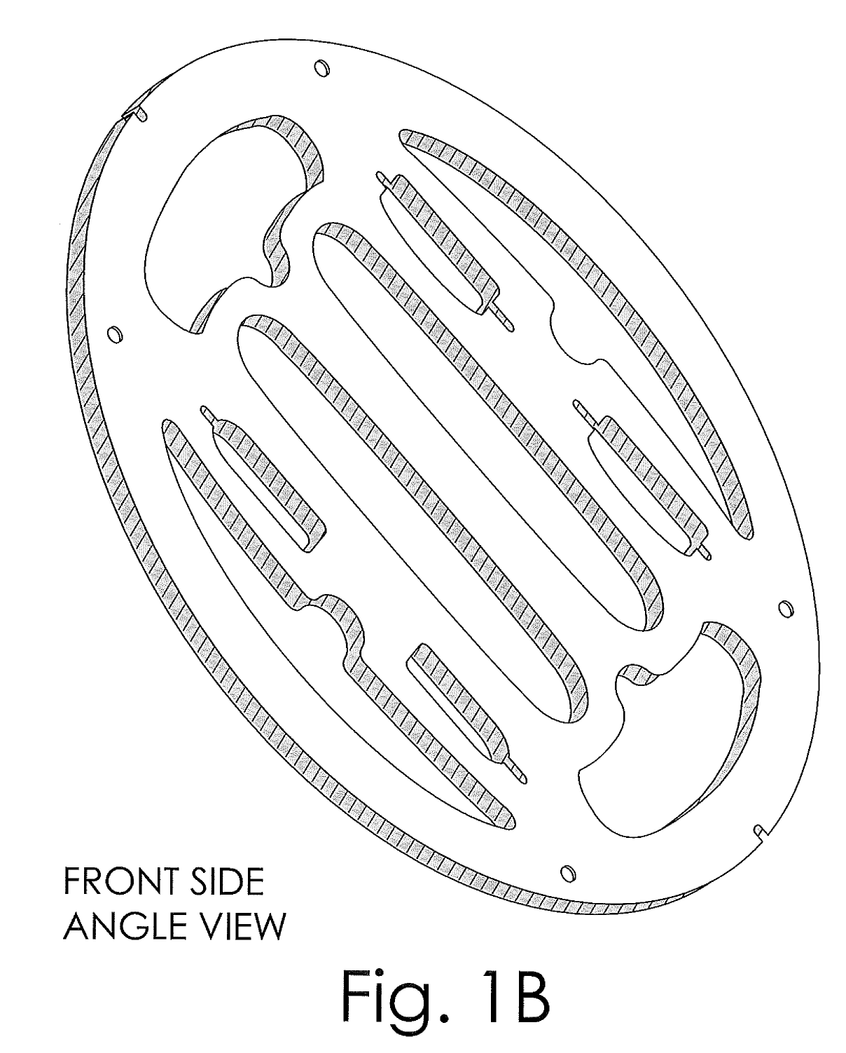

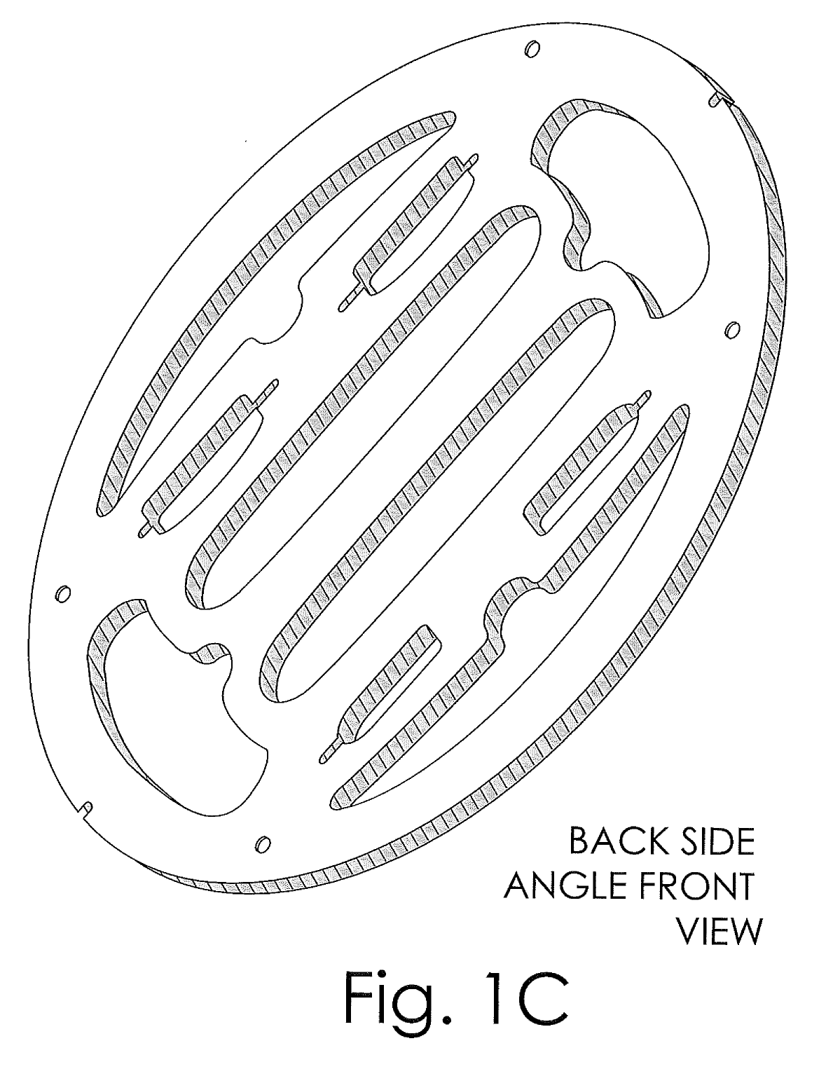

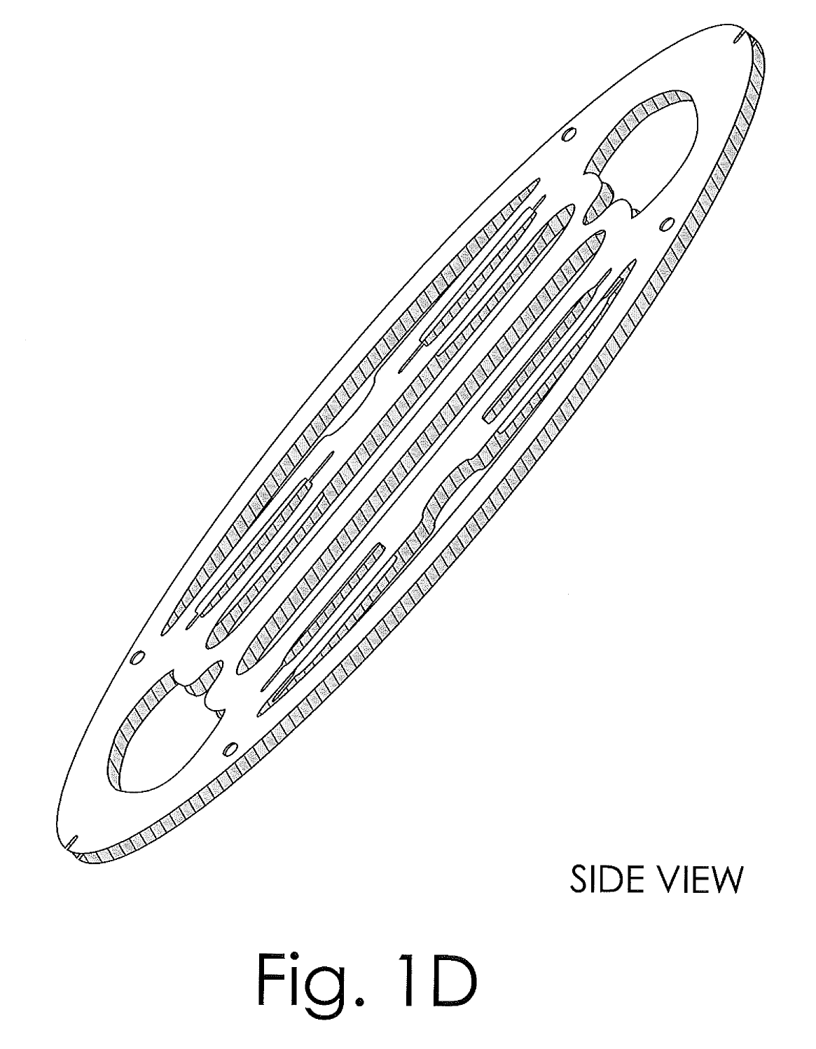

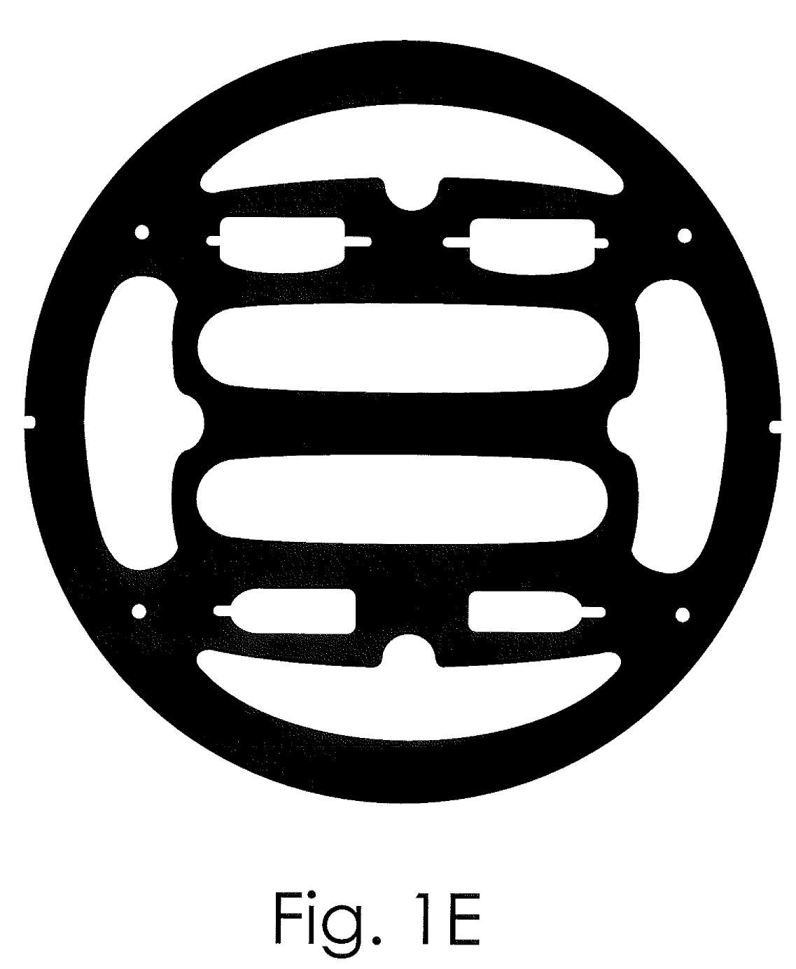

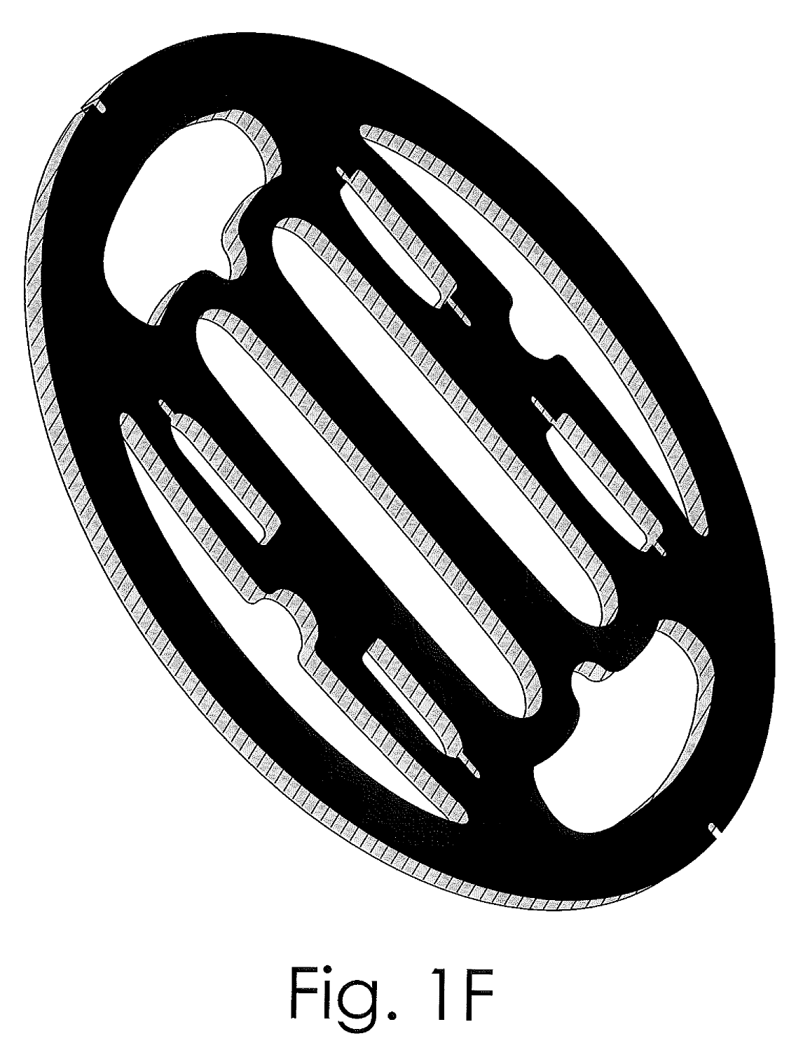

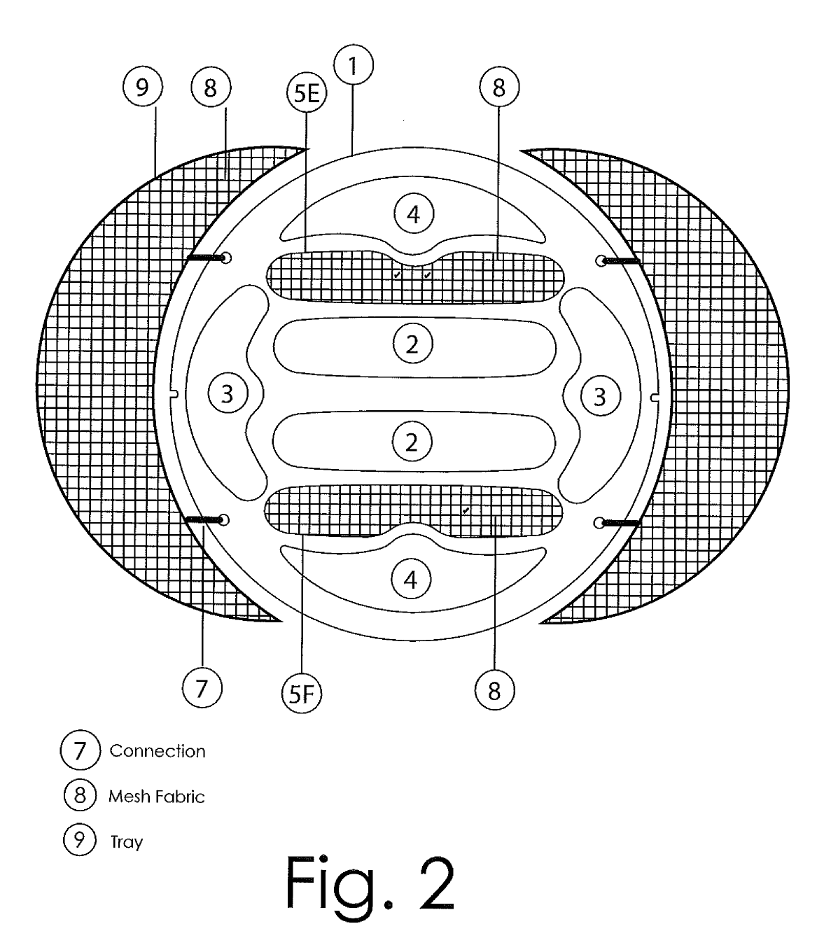

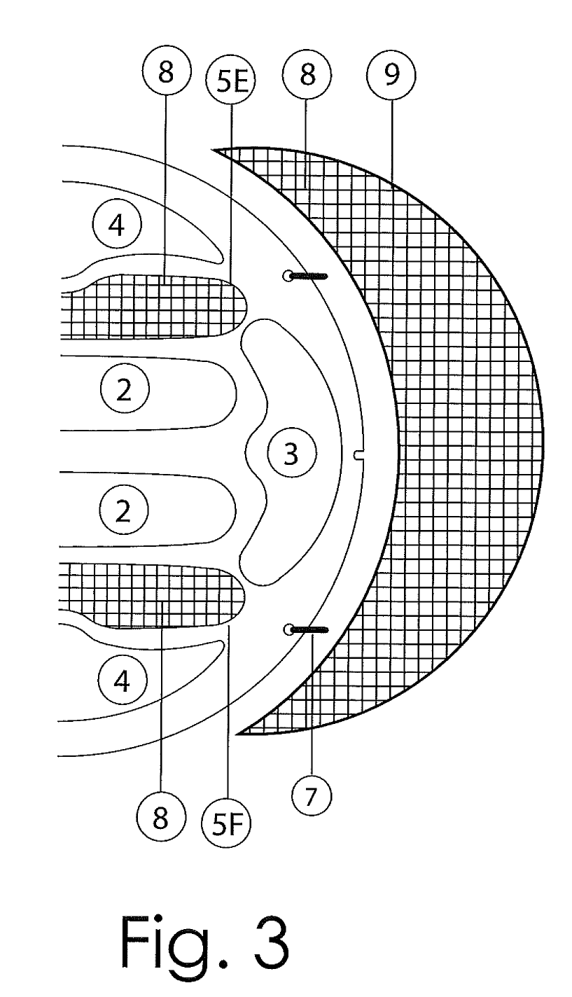

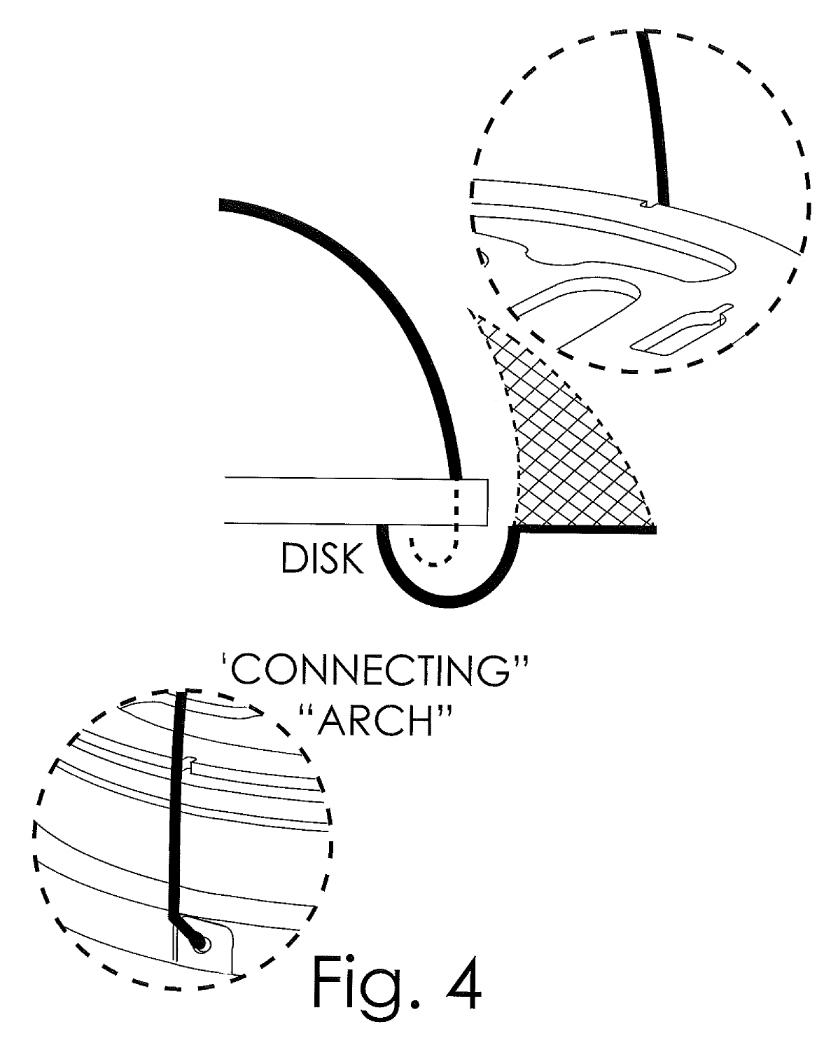

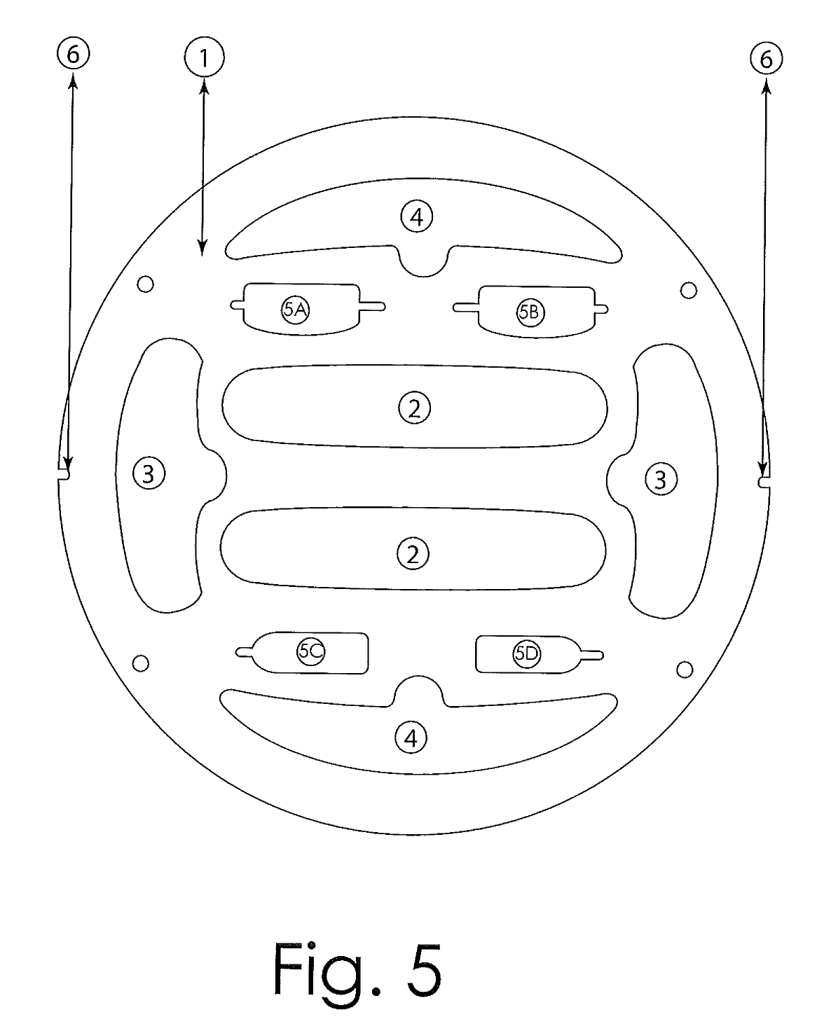

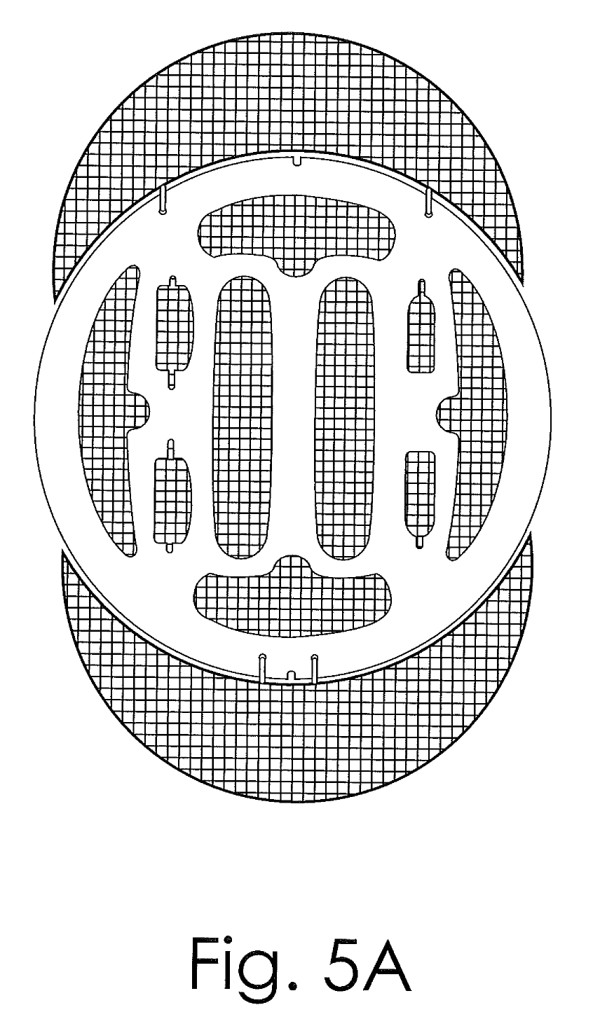

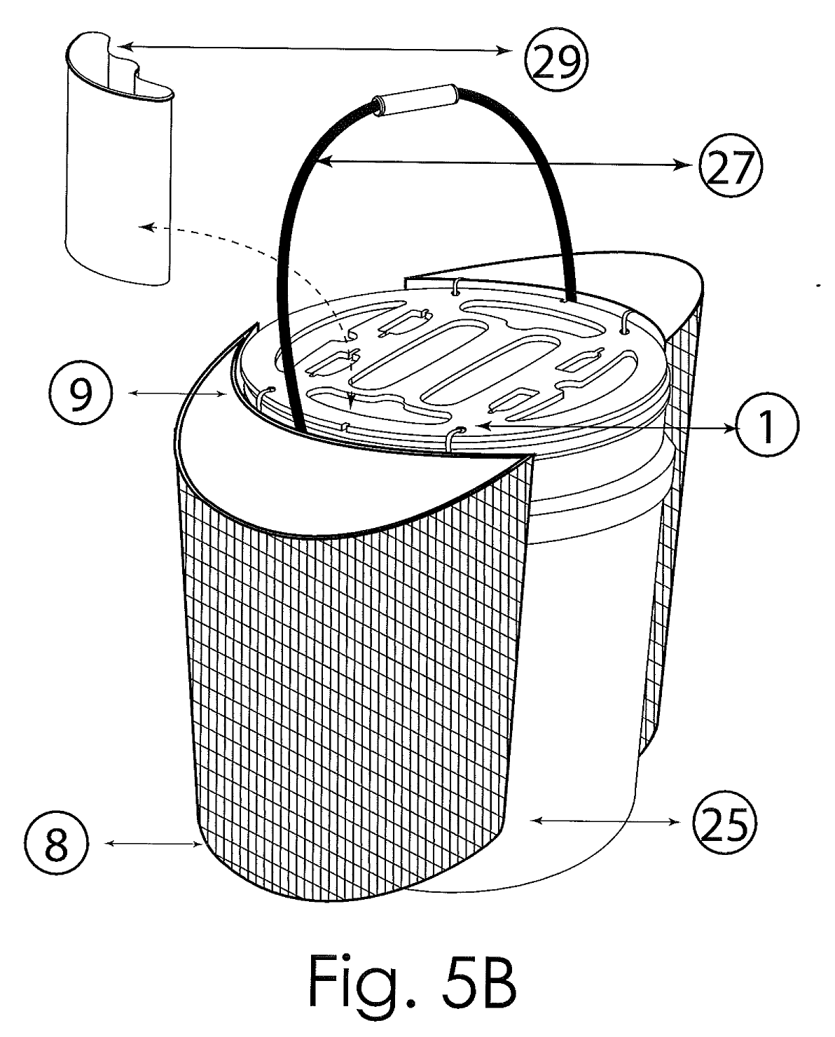

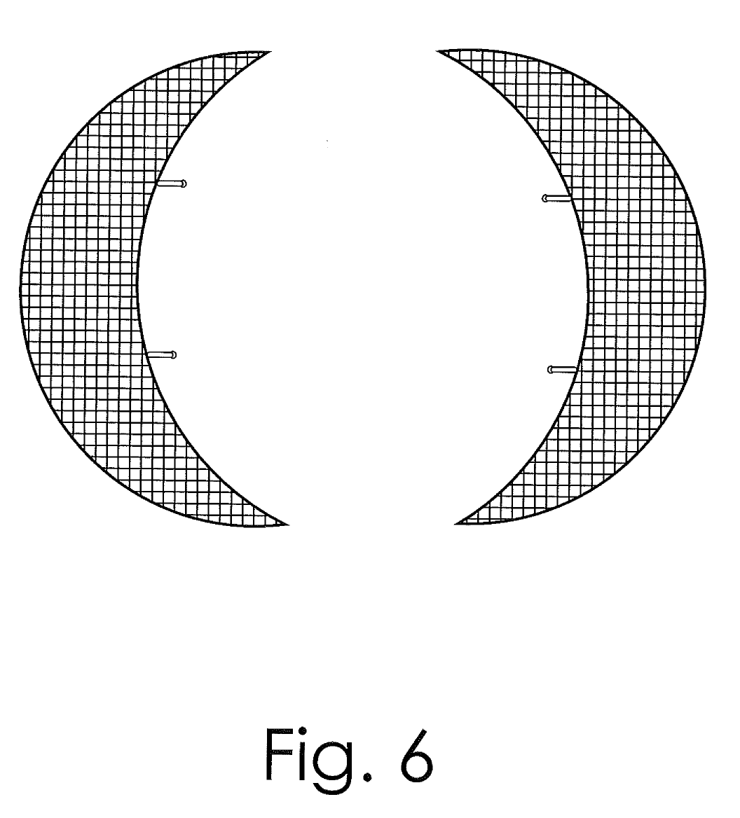

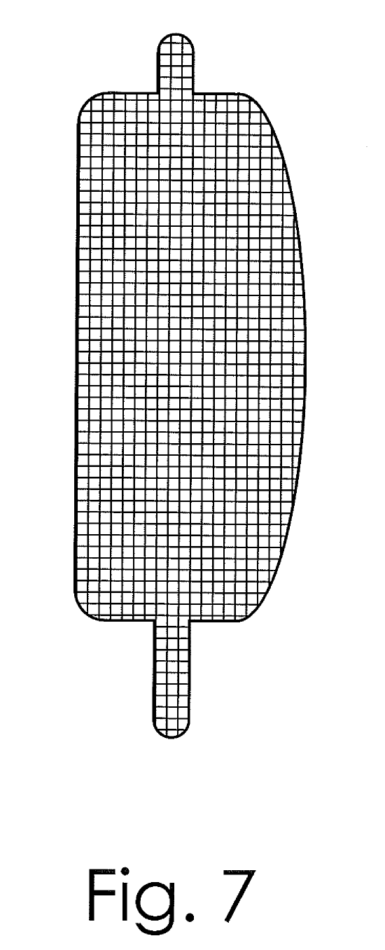

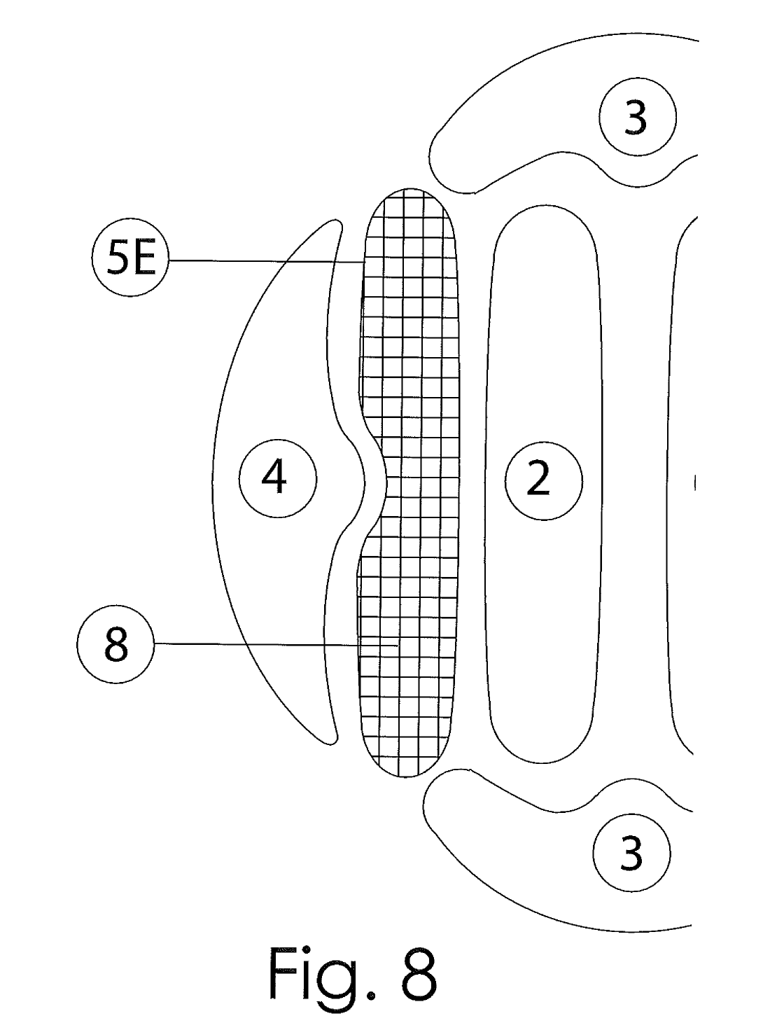

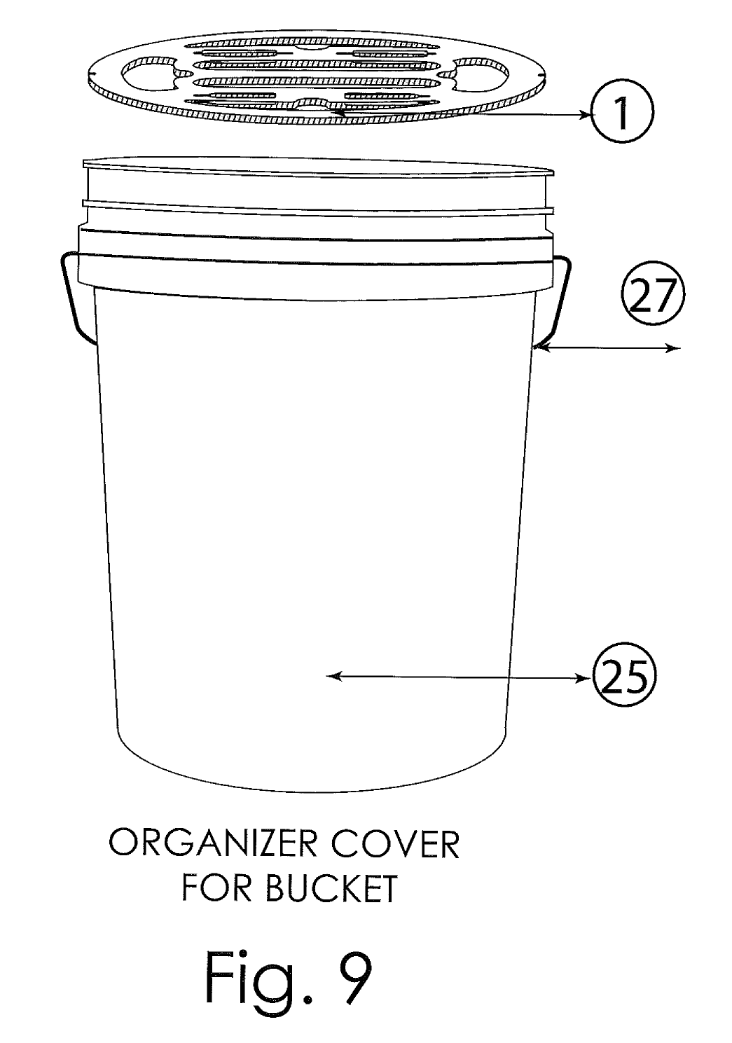

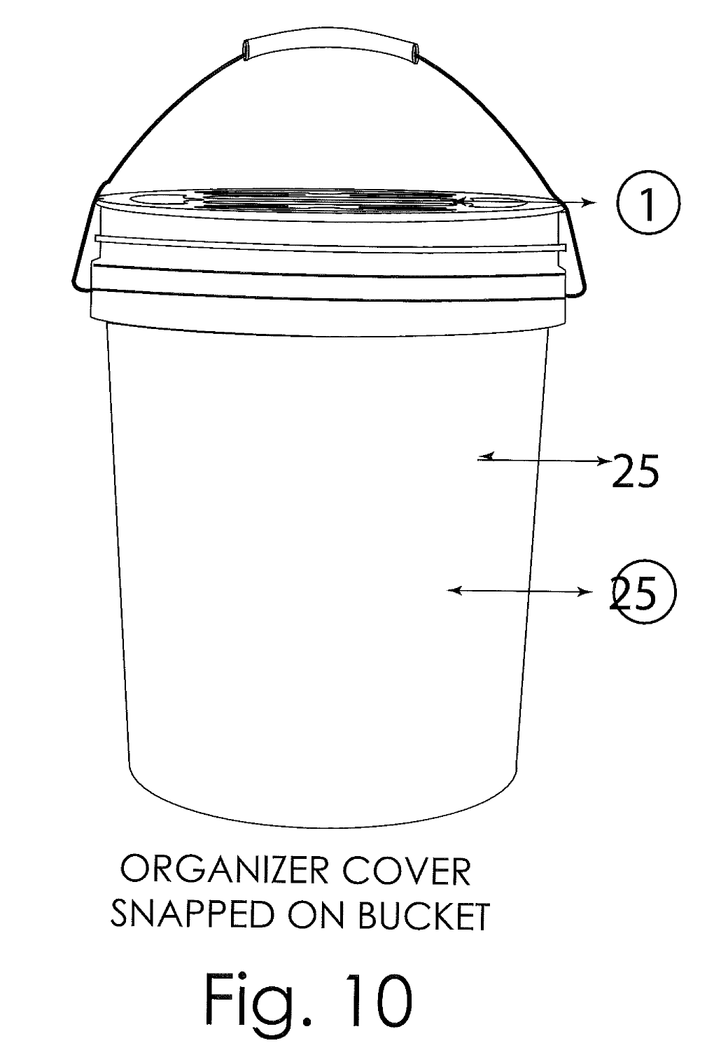

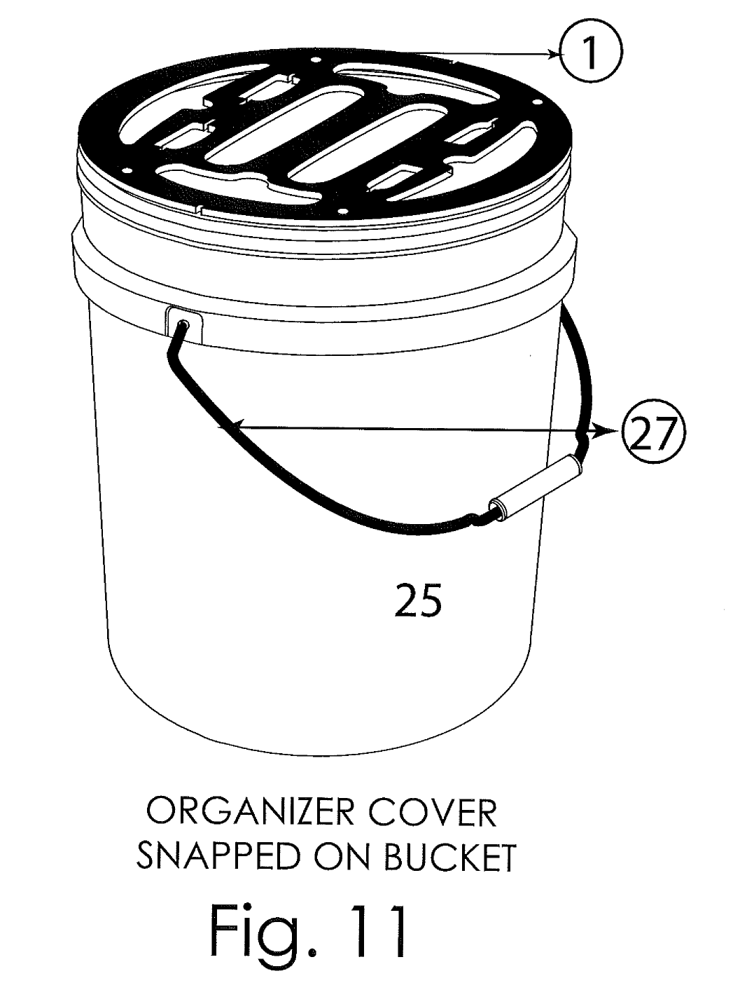

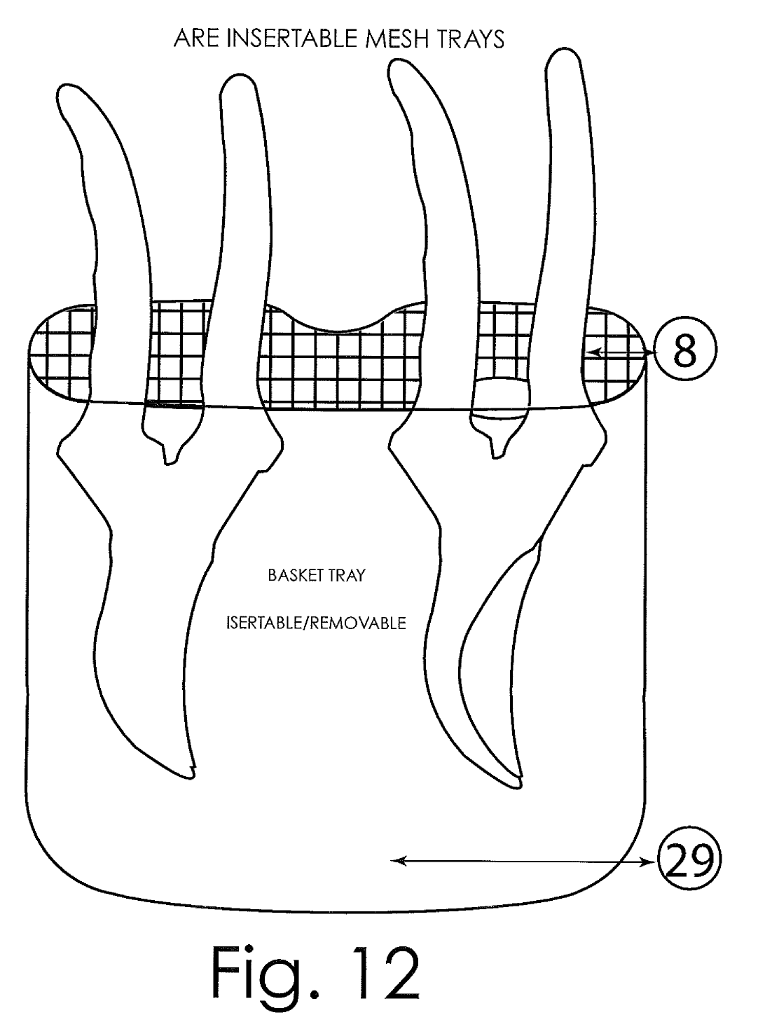

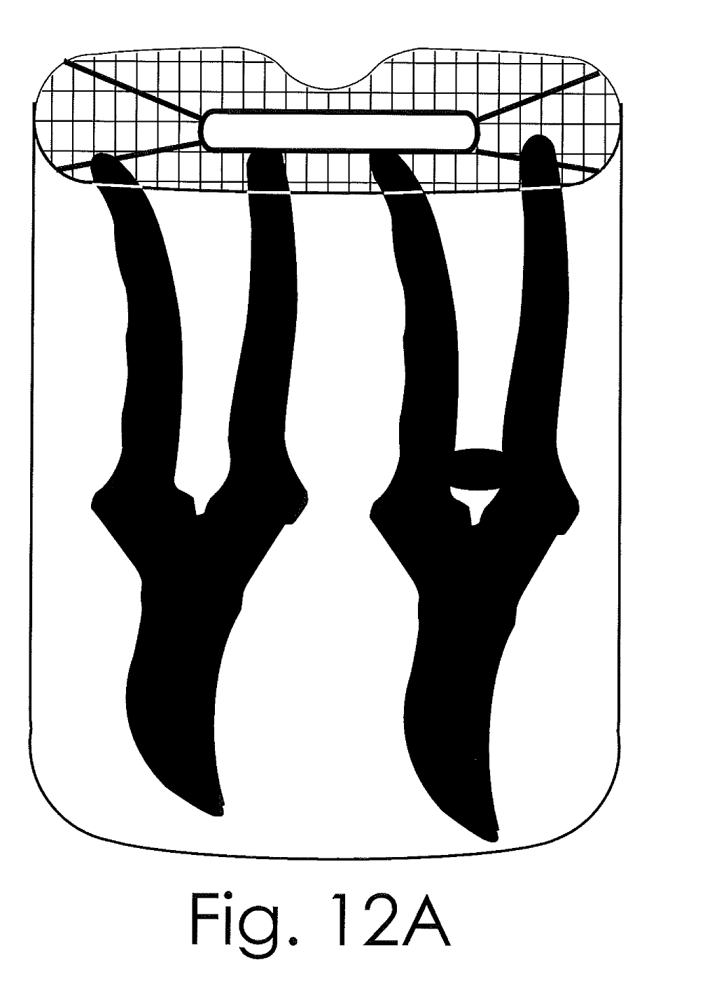

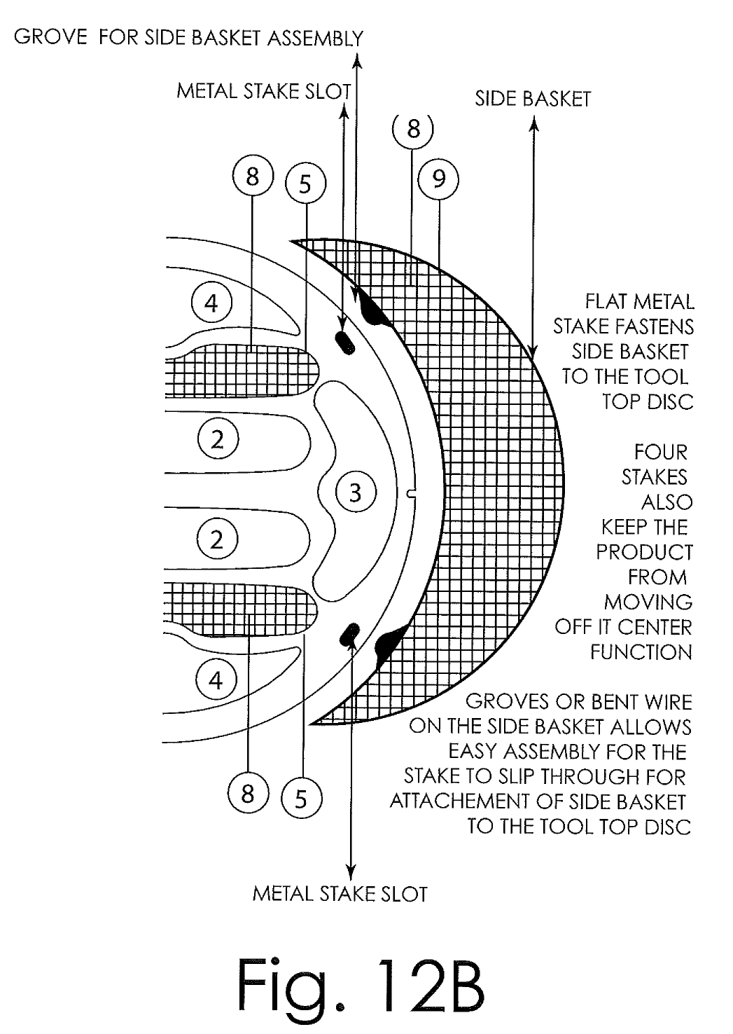

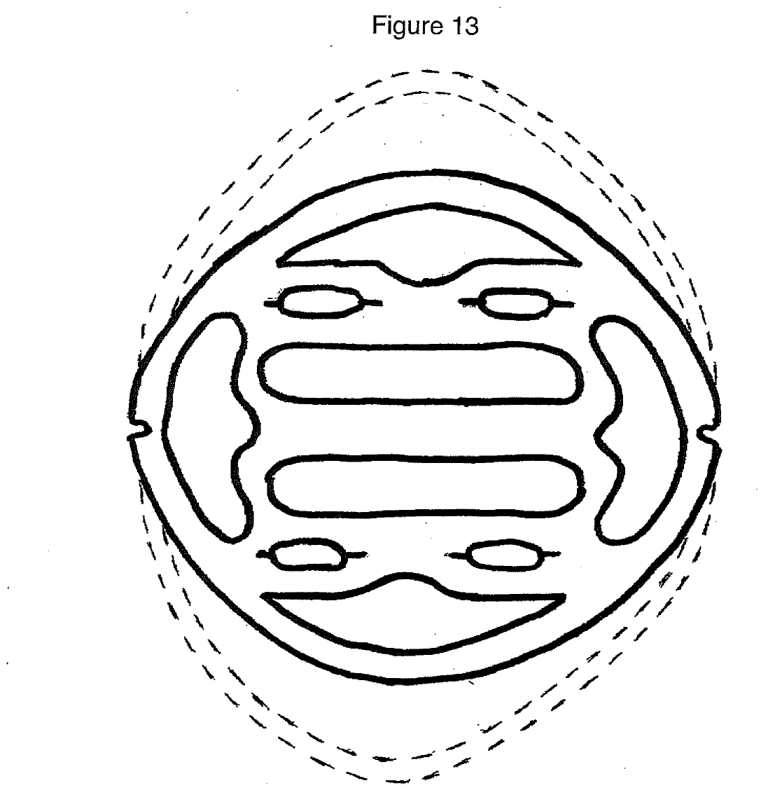

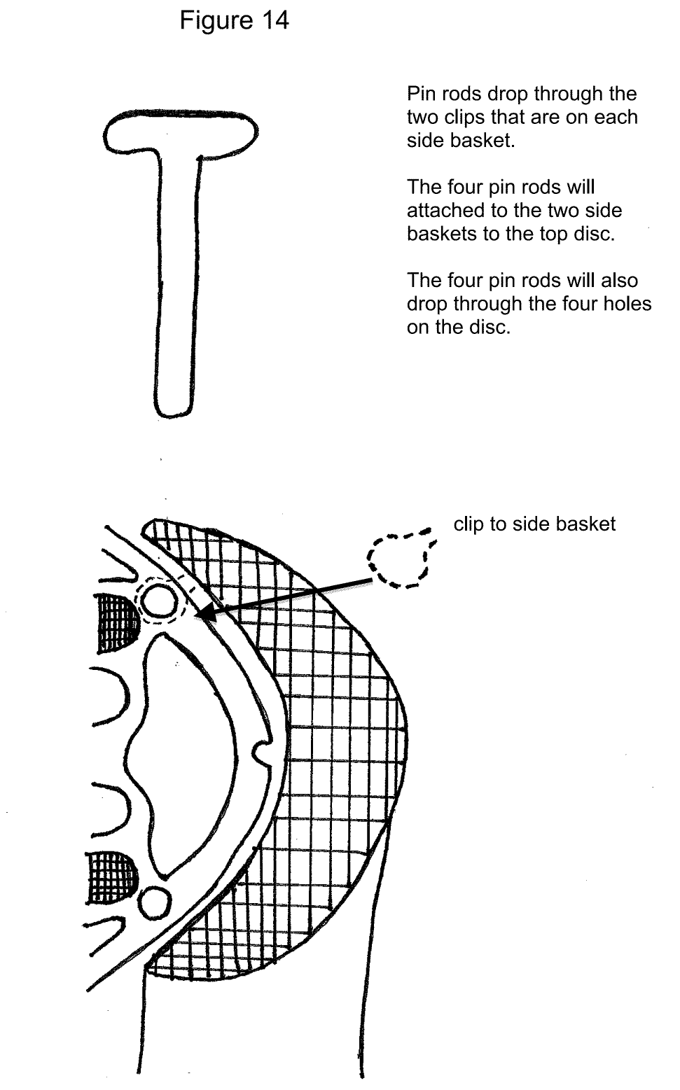

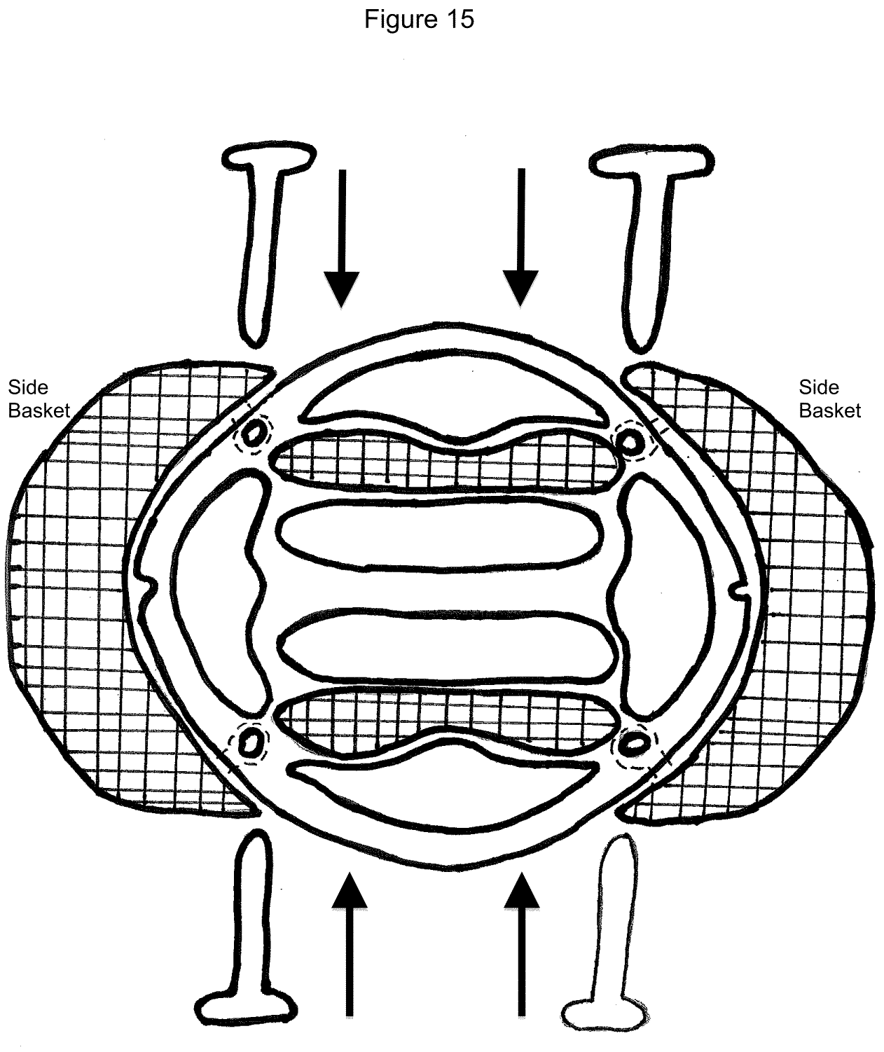

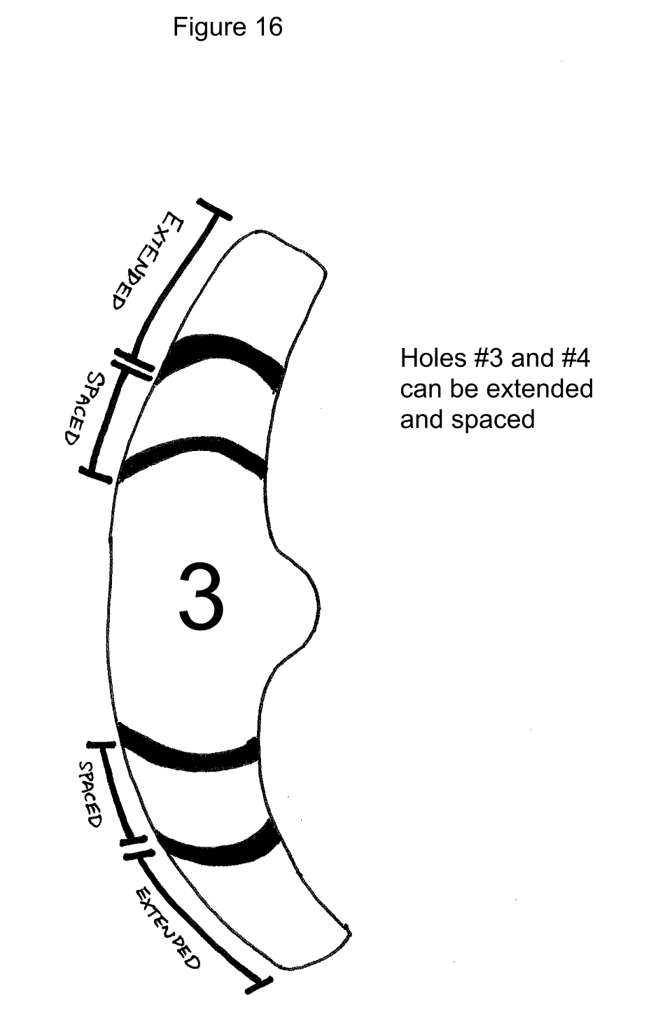

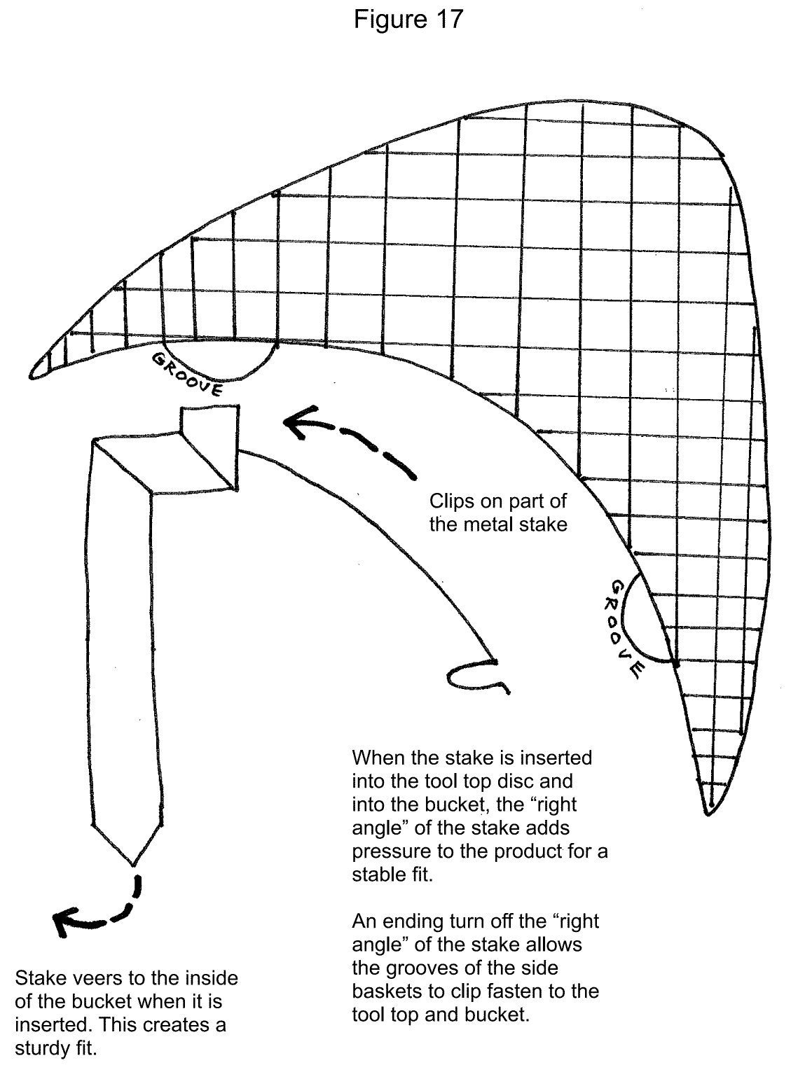

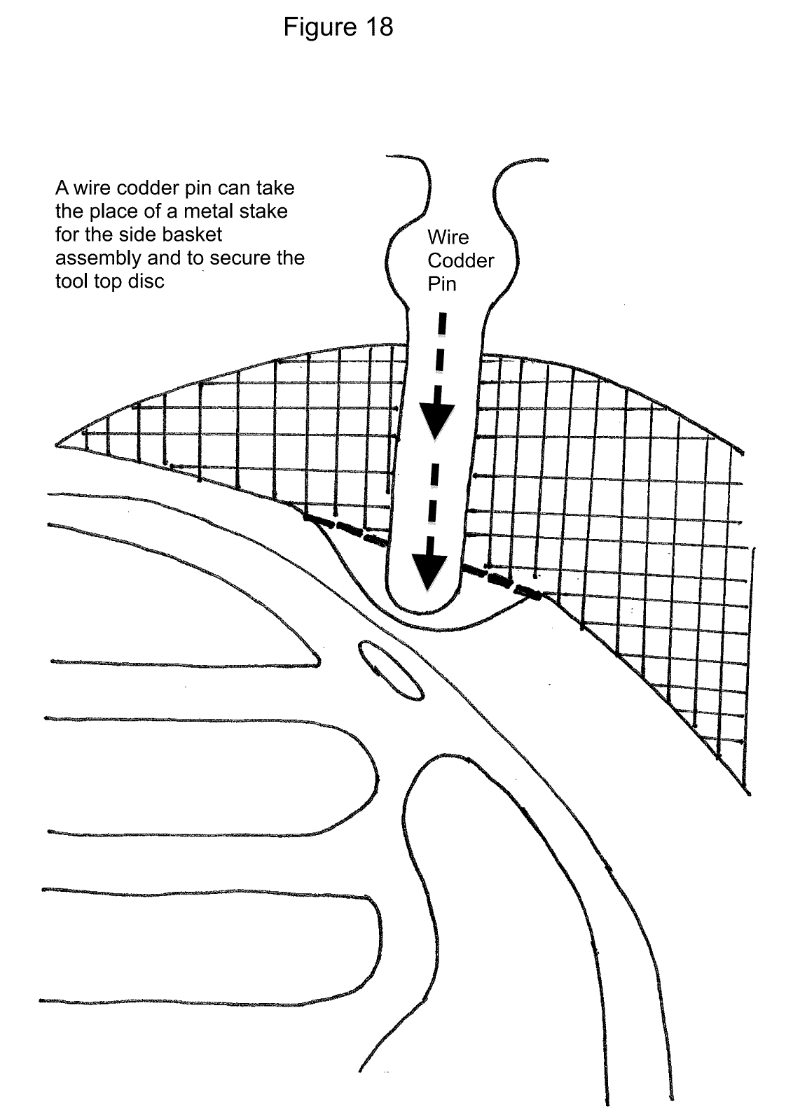

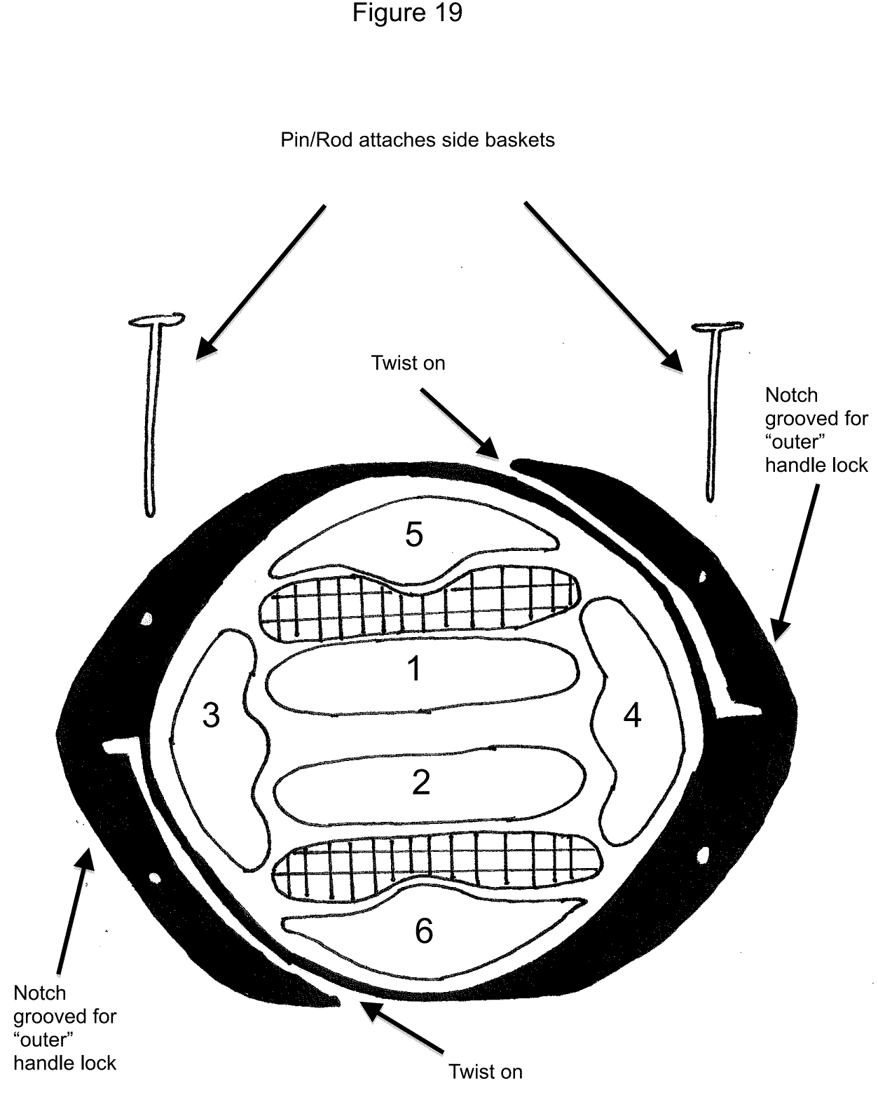

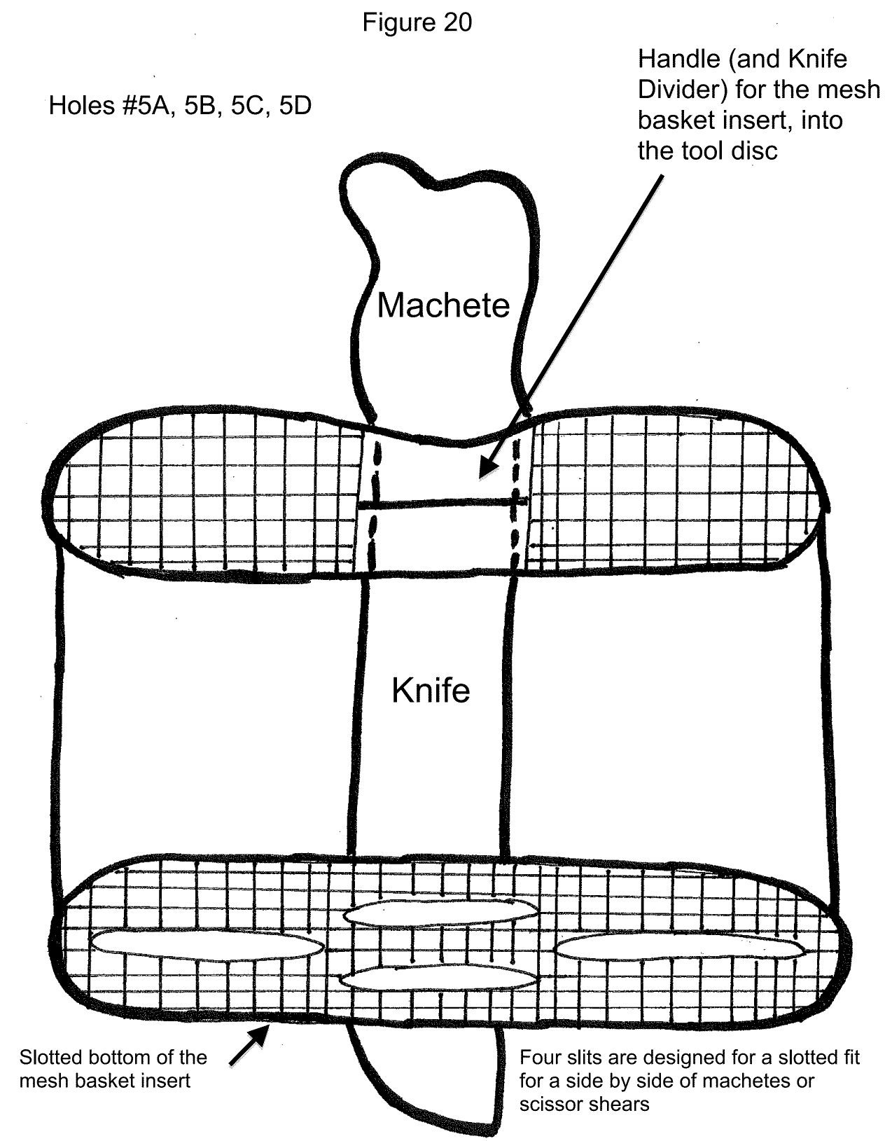

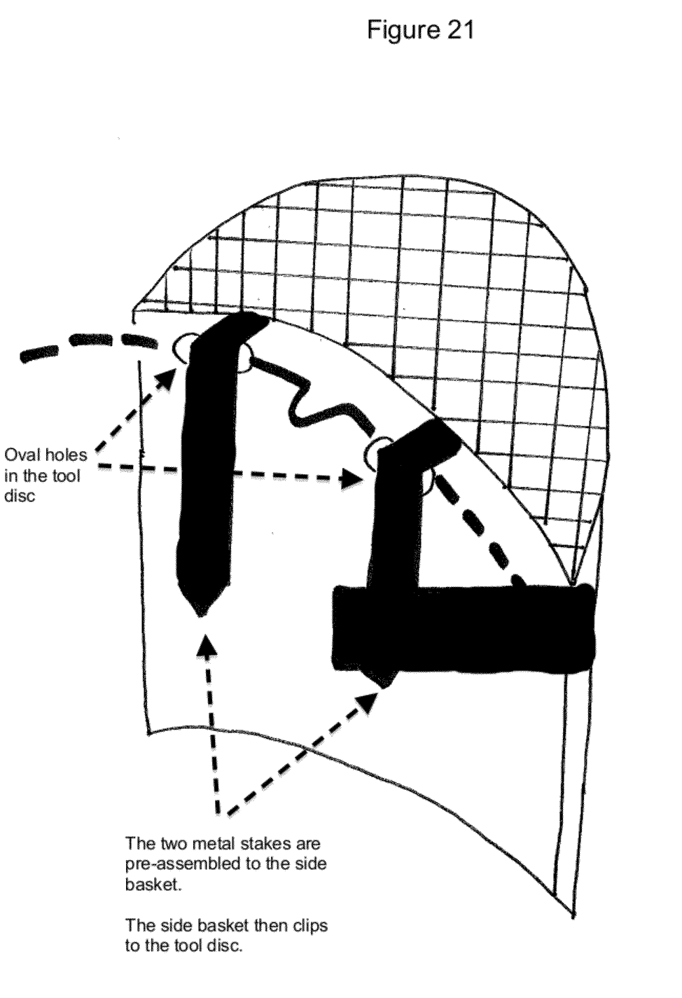

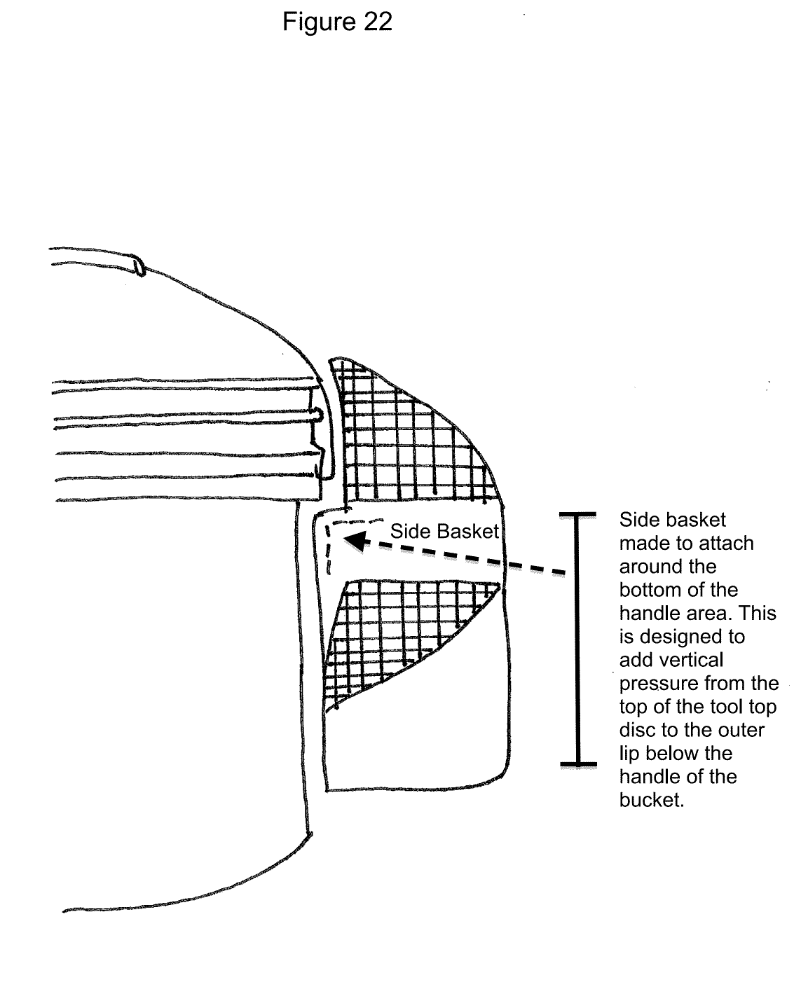

FIG. 2 is a prospective surface view of the garden caddy lid with the present invention's attachable side mesh baskets/trays at FIG. 2(9) and the associated mesh fabric used in such side mesh baskets/trays at FIG. 2(8). Also shown in FIG. 2 is an alternative embodiment of the garden caddy lid. In the embodiment shown in FIG. 2, the small oval holes referred to in FIGS. 1(5A) and 1(5B) are now replaced with inner mesh slots as illustrated in FIG. 2(5E), which utilizes mesh fabric as illustrated in FIG. 2(8), and the small oval holes referred to in FIGS. 1(5C) and 1(5D) are now replaced with inner mesh slots as illustrated in FIG. 2(5F), which utilizes mesh fabric as illustrated in FIG. 2(8).
FIG. 2(2) through FIG. 2(4) are identical to images 1(2) through 1(4).
FIG. 2(7) depicts the placement of the present invention's connection arches. These connection arches connect the attachable side mesh basket/trays to the garden caddy lid.
FIG. 2(8) illustrates mesh fabric and its placement within the present invention's respective areas.
FIG. 2(9) depicts the garden caddy's attachable side mesh baskets/trays.

FIG. 3 is a partial frontal view of the garden caddy lid with attachable side mesh basket/trays.

FIG. 4 is a partial side view depicting the placement and means for attaching the connecting arches as illustrated by their placement in relation to the respectable handle.

FIG. 5 depicts another embodiment of the present invention.

FIG. 5A is an elevated surface view of the garden caddy lid, which includes the same hole and cutout placements of the prior embodiments but has incorporated meshing into every aperture for a customized fit for tools and utensils.

FIG. 5B depicts the garden caddy lid (1) placed on top of a tool bucket (25) with the tool bucket handles (27) securing the current garden caddy lid. FIG. 5B also depicts an attachable side mesh basket/tray (9) with mesh fabric (8) as well as insert-trays (29), which can be shaped to be used with any of the garden caddy lids' per-designed holes.

FIG. 6 is an elevated surface view that isolates the attachable side mesh baskets/trays.

FIG. 7 is an elevated surface view of a new embodiment of FIG. 1(5A) through 1(5D).

In this embodiment the aperture is shaped differently and lined with a meshing for a more customizable use.

FIG. 8 is a close-up of a portion of FIG. 2.

FIG. 9 depicts the garden caddy lid (1) prior to placement on the bucket (25) and the bucket's handle (27).

FIG. 10 depicts the garden caddy lid (1) once it has been snapped into place on the bucket (25) and the bucket's handle (27).

FIG. 11 depicts the garden caddy lid (1) once it has been snapped into place on the bucket (25) and the bucket's handle (27) without using the bucket's handles for snap-in support.

FIG. 12 depicts the attachable side mesh basket/tray (29) showing how tools are inserted, organized and stored in the mesh fabric (8).

FIG. 12A depicts the attachable side mesh baskets/trays showing how tools are inserted, organized, and stored in the mesh fabric with the tools being shaded-in for convenience.

FIG. 12B is another embodiment showing the alternative manner in which the attachable side mesh basket/tray (9) may be attached to the garden caddy lid. Four flat, metal stakes fasten the side basket (9) to the top of the garden caddy lid by being inserted into metal stake slots. The insertion of the four flat, metal stakes to the garden caddy lid keep the product from sliding off its centered function.

FIG. 13 depicts another embodiment of the invention where the invention is extended into an oval, football-like shape (illustrated by dotted lines), which allows for more storage space of tools outside of the actual bucket.

FIG. 14 depicts the placement of a pin-rod, which drops through a clip that is on each side of the attachable side mesh basket/tray and attaches the attachable side mesh basket/tray to the garden caddy lid.

FIG. 15 depicts the placement of four pin-rods, which drop through the clips located on each side of the attachable side mesh basket/tray and attach the attachable side mesh basket/tray to the garden caddy lid.

FIG. 16 depicts the option of extending the amount of storage space for the holes in the garden caddy lid.

FIG. 17 depicts a flat, metal stake that attaches the garden caddy lid and bucket to the attachable side mesh basket/tray by inserting the stake into the per-designed grooves of the attachable side mesh basket/tray.

FIG. 18 depicts an alternative embodiment to the embodiment illustrated in FIG. 17 in which a cotter pin is used attach the attachable side mesh basket/tray to the garden caddy lid and bucket instead of a flat, metal stake.

FIG. 19 depicts the caddy garden lid utilizing a groove that allows the garden caddy lid to twist into place and secure itself to the bucket by locking around the bucket's handle.

FIG. 20 depicts the placement of mesh fabric at the bottom of the mesh trays, which allow larger tools that extend beyond the space afforded by the tray to maintain secure storage within the tray.

FIG. 21—The stakes or other attachment piece are part of the side attachable basket and snaps into place attaching to lid.

FIG. 22—side bucket shown conforming to shape of bucket resting against side of bucket.

### DETAILED DESCRIPTION

The present invention incorporates aspects and features of modern garden tool caddies with those of a traditional bucket and container in a novel and significant fashion. A garden tool caddy is a device in which garden tools can be supported for easy and convenient transportation. In a garden tool caddy device, tools are often supported by holes or slits within an apparatus in which they are held into place in an effort to maximize the effectiveness and efficiency of their mobilization. A traditional and generic 5 gallon bucket, as commonly sold in hardware stores, is also a primary tool of gardening and landscape work. Rather than having to carry the bucket in addition to a tool caddy, or just sloppily and dangerously tossing all tools in the bucket, the present invention allows an adapted bucket or container to serve as a safe, simple, and effective means for tool transport.

The present invention incorporates a novel and innovative arrangement of a garden tool caddy with a traditional 5 gallon bucket or container, in order to enhance the ease of transporting gardening tools, and facilitating safety, and organization and storage. By incorporating all of these features into its unique design, the present invention satisfies a current market demand for a cost-efficient, convenient, simple, and safe product. The garden caddy lid of the present invention, shown in FIG. 1, has incorporated a plethora of uniquely designed features to accomplish the inventions several aforementioned objectives. The features include: two middle oval holes, two split bucket handle holes, two outer rim holes, and four mini oval holes. Each of these holes are specifically designed to firmly secure and support intended implements, thus fostering the safe mobilization and organization of the implements.

The drawings refer to an ordinary, common, five gallon bucket or container having a removable caddy lid, as illustrated in FIG. 10. The attachable caddy lid secures to the side walls and top rim of the bucket referred to in FIG. 10. The caddy lid is attached by fitting over the bucket rim and securing an inner and outer lip over the sidewalls of the bucket as shown attached in FIG. 54. The caddy lid has prearranged indentations, which are set for procurement of the bucket handle. The prearranged indentations, referred to in FIG. 1, allow the current invention to utilize the handle of an ordinary bucket or container to serve as the carrying device for the present invention.

As shown in FIG. 1, the two middle oval holes are specially designed to accommodate and secure, hold, store, organize, and carry: Loppers of up to 4 ft long, gardening shears, sledge hammers, shovels of up to 3 feet long, saws of up to 3 feet long, painter tools, golf course maintenance tools, barbecue utensils, brooms, dust pans, grabber sticks, machetes, knives, hatchets, watering wands, tree stakes, and other appropriately sized hand-tools.

The two split handle holes, depicted in FIG. 1, are specially shaped to accommodate and secure, store, hold, organize, and carry: hammers, hatchets, hand shovels, axes, trenchers, mini racks and claws, stakes, and other smaller hand tools such as painter tools, barbecue utensils, brooms, dust pans, grabber sticks, machetes, knives, watering wands, and rolling measuring sticks.

The outer two outer rim holes, depicted in FIG. 1, are uniquely shaped to firmly and safely secure, hold, store, organize, and carry shovels of up to three feet, hedge shears, and mini loppers. The additional four mini oval holes, depicted in FIG. 1, are designed to securely hold in place, store, organize, and carry: hand-pruners, saws, shears, scissors, machetes and knives, folding grabber sticks, and stakes.

This present invention enhances a customer's gardening experience in a multitude of ways. First, the present invention employs several features for the purpose of increased safety. The present invention employs handle notches/grooves, which allow the bucket handle to slide and lock into place for better balance and increased safety. The notched handle procurements, located on the outside perimeter of the present invention, support the balancing and mobilization of a tool-loaded bucket by restricting the transfer of momentum onto the pivotal handle. By eliminating the handle's ability to pivot, the present invention mitigates the swinging back and forth of the tool-loaded bucket and greatly reduces the possibility of the handle swinging into a sharp tool and injuring the user. Additionally, the incorporated handle slits, as show in FIG. 19, allow the user to slide the handle around the lid and then fit it securely into place. Another feature incorporated into the present invention to increase the safety of the unit is the specially designed tool holes. As described above, these holes come in several sizes so that a variety of tool shapes are accommodated. These specially designed holes are made to uniquely fit and secure appropriate size instruments from moving around when the garden caddy is being transported. By securing such implements in place, the present invention decreases the chance of sharp tools sliding around, or falling out of the bucket, and injuring the user during transportation. In order to implement this safe design, the present invention may utilize Styrofoam wedges and/or clip away meshing within the lid's insert holes, as shown in FIG. 20. The inclusion of Styrofoam wedges and, or clip away meshing allows the present invention to better secure, hold, and/or carry the implements in place. These features of the current invention assure tools are held securely with minimal space for unwanted movement.

The second purpose of the present invention is to facilitate tool organization and storage. The present invention is designed with the intent of convenient storage and organization in mind. Prearranged and cut holes within the caddy lid make it easy to find the exact tool you are looking for. These holes prevent the smaller tools from falling to the bottom and being covered and hidden by the larger tools on top. Another added benefit of prearranged holes specifically intended for certain implements is that they makes it easier for the user to notice any missing tools. An empty slot is a simple and obvious indicator that a tool may have been left behind in the garden or elsewhere.

The inclusion of a bucket as part of the design is also a mindful incorporation of the present invention. By including an ordinary five gallon bucket as part of the garden caddy, the invention is a standalone all-in-one, pick-up-and-go, storage device. This inclusion eliminates the need for tool racks, gardening buckets, and gardening caddies all being stored separately and thus additionally saves space. In addition to the aforementioned benefits, the present invention eliminates the need for the user to gather their tools and transport them individually to their preexisting caddy device, as the current invention provides the means for all tools to already be neatly stored within the present invention.

The specialized bucket lid of the present invention can also be an oval, football-like shape to increase the garden caddy's tool carrying abilities. In this embodiment, the lid's two most longitudinal ends hang past the outer walls of the bucket. This extension beyond the buckets' walls effectively increases the bucket's carrying volume. Utilizing this feature additional implements, which would not fit within the bucket before, can now also be inserted and supported by the lid.

It is yet another objective of the current invention to accommodate an attachable mesh side tray which can be added for further carrying capacity and ability. The attachable mesh side tray is supported by arches that connect them to the bottom of the notched area along the rim of any ordinary five gallon bucket. While the specialized lid holes are well designed to carry tools and other implements as is, the inclusion of clip away meshing also allows the user to customize the caddy to his specific needs.

The present invention also employs a unique design specifically intended to create a cost-efficient product to meet market demand. Current garden caddies on the market are as stand alone units. Likewise, so are common ordinary five gallon buckets or containers. To induce cost-efficiency the present invention is designed in two preferred embodiments. One embodiment is tailored for those consumers who already own a five gallon bucket or container, while the other is tailored to those consumers who do not already have an ordinary bucket. The preferred embodiment, which includes both the five gallon bucket and the garden caddy lid as one product, offers the consumer who does not own a five gallon bucket the option of receiving both within a single purchase. For those consumers that already have a five gallon bucket as part of their gardening equipment, the garden caddy lid can be sold separately at a lower cost. These alternative embodiments offer a cost-efficient invention to meet the current market demand. The present invention can be used to carry, hold, organize, and/or store any types of tools for any purposes including, but not limited to, gardening tools.

While the instant invention has been shown and described in accordance with preferred and practical embodiments thereof, it is recognized that departures from the instant disclosure are contemplated within the spirit and scope of the present invention. Therefore, the true scope of the invention should not be limited since other modifications will become apparent to those skilled in the art upon a study of the description, drawings, specifications, claims, abstract, and the following paragraphs.

What is claimed is:

1. A device for organizing, holding, storing and/or carrying tools comprising at least one of: a container lid or a lid shaped device having at least one of: slit(s), groove(s), cut-out(s), pockets, netting, meshing, compartments, buckets, notches, trays, and/or hole(s).

2. The invention in claim 1 wherein at least one of the various slit(s), groove(s), cut-out(s), pockets, netting, meshing, compartments, buckets, notches, trays, and/or hole(s) are for the vertical placement, insertion, separation, support, and/or storage of a multitude of tools;

3. The invention in claim 1 wherein said lid or lid shaped device is sized to rest on top of the upward opening of a container and partially, or wholly, align with container's diameter and perimeter walls;

4. The invention in claim 3 wherein said lid's or lid shaped device's openings are positioned so the various tools that are inserted are positioned, and/or held in place, and/or supported into and/or around a container.

5. he invention in claim 4 wherein said container is comprised of a bucket, serving as an upward open receptacle device for the support of tools.

6. The invention in claim 5 wherein said tools include at least one of: gardening tools, electrical tools, plumbing tools, auto-mechanical tools, and/or household tools.

7. The invention in claim 5 wherein said bucket has an attached pivotal handle fastened to at least one of its outer diametrical walls;

8. The invention in claim 7 wherein said lid or lid shaped device has slit(s), groove(s), cutout(s), and/or notche(s) on its outer diameter for which the bucket's pivotal handle fits within when said handle is inclined into its most upward vertical carrying position;

9. The invention in claim 8 wherein said lid or lid shaped device further incorporates at least one attachable side mesh basket(s), tray(s), pocket(s), compartment(s), meshing, and/or netting;

10. The invention in claim 9 where at least one of said attachable side mesh baskets, pockets, compartments, and/or trays hang in alignment underneath at least one of the lid or lid shaped device's openings, hole(s), notche(s), tray(s), cut-out(s), and/or groove(s) ;

11. The invention in claim 9 where at least one of said attachable side meshing, baskets, pockets, compartments, and or trays is attached to at least one of the outer walls of the lid, thus creating at least one of a removable mesh, netting, basket, pocket, compartment, cut-out, groove, hole, and/or tray, which extends the total surface area and carrying volume and capabilities of the present invention;

12. The invention in claim 9 wherein at least one of said attachable side mesh, baskets, netting, pockets, compartments, and/or trays may be attached to at least one of the outer walls of the specialized lid or lid shaped device. through the use of a connecting device.

13. The invention in claim 12 wherein the connecting device is a flat and/or round, metal, rubber, and/or plastic, stake, pin, hook, latch, hinge and/or clip.

14. The invention in claim 1 wherein one or more of said lid or lid shaped device's slit(s), groove(s), cut-out(s), pockets, netting, meshing, compartments, baskets, notches, trays and/or hole(s) are differentially shaped and at least two or more are of different sizes.

15. The invention in claim 1 wherein at least one of said lid or lid shaped device's slit(s), groove(s), cut-out(s), notch(es), tray(s), pocket(s), netting, meshing, compartment(s), basket(s) and/or hole(s) are interlined with a material and/or fabric to conform to the shape of the inserted implement and secure it within the respective slit, groove, cut-out, notch, tray, pocket, netting, meshing, compartment, basket, and/or hole.

16. The invention in claim 15 wherein said material is at least one of cotton, wool, nylon, Styrofoam, rubber, plastic, netting, and/or meshing.
